(19) United States
(12) Patent Application Publication
(10) Pub. No.: US 2005/0152773 A1
(43) Pub. Date: Jul. 14, 2005

(54) Liquid epoxy resin composition and semiconductor device

(75) Inventors: Kazuaki Sumita, Gurma-ken (JP); Hiroyuki Takenaka, Gurma-ken (JP); Tsuyoshi Honda, Gurma-ken (JP)

Correspondence Address: BIRCH STEWART KOLASCH & BIRCH, PO BOX 747, FALLS CHURCH, VA, 22040-0747, US

(73) Assignee: Shin-Etsu Chemical Co., Ltd.

(21) Appl. No.: 11/007,208

(22) Filed: Dec. 9, 2004

(30) Foreign Application Priority Data
Dec. 12, 2003 (JP) 2003-415182
Dec. 12, 2003 (JP) 2003-415202

(51) Int. Cl. B65G 1/00; B66F 1/00

(52) U.S. Cl. 414/664

(57) ABSTRACT

A liquid epoxy resin composition comprising (A) a liquid epoxy resin, (B) an aromatic amine curing agent, and (C) an inorganic filler having an average particle size of more than 5 μm in an amount of from 300 parts by weight to 1,000 parts by weight per 100 parts by weight of components (A) and (B) combined, has a low viscosity and a low coefficient of linear expansion and is suited for the encapsulation of semiconductor devices.

### CROSS-REFERENCE TO RELATED APPLICATION

This non-provisional application claims priority under 35 U.S.C. §119(a) on patent application Nos. 2003-415182 and 2003-415202 filed in Japan on Dec. 12, 2003 and Dec. 12, 2003, respectively, the entire contents of which are hereby incorporated by reference.

### TECHNICAL FIELD

This invention relates to a liquid epoxy resin composition which cures into a product having high humidity resistance and is suitable as an encapsulant having improved thermal shock resistance at a reflow temperature of at least 250° C., especially at least 260° C. It also relates to a semiconductor device which is sealed with the liquid epoxy resin composition.

### BACKGROUND OF THE INVENTION

The trend toward smaller sizes, lighter weights and increased capabilities in electrical equipment has led to a shift in the dominant semiconductor mounting process from pin insertion to surface mounting. The progress of semiconductor devices toward a higher degree of integration entails the enlargement of dies to a size as large as 10 mm or more per side. For semiconductor devices using such large size dies, greater stresses are applied to the die and the sealant during solder reflow. Such stresses give rise to unwanted problems including delamination at the interface between the sealant and the die or substrate, and cracking of the package upon substrate mounting.

The progress of the LSI manufacturing process toward finer feature sizes revealed a problem of wiring delay. One effective means for mitigating the wiring delay problem is to reduce the wiring parasitic capacity. To reduce the wiring parasitic capacitance, efforts have been made on the development of low-dielectric-constant interlayer dielectrics having a lower relative dielectric constant k (1.1 to 3.8). For example, doped silicon oxide films such as SiOF, organic polymer films, and porous silica are used as the low-dielectric-constant interlayer dielectrics, but they tend to reduce mechanical strength and thermal conductivity. In semiconductor devices using such low-dielectric-constant interlayer dielectrics, greater stresses are applied to the low-dielectric-constant interlayer dielectric and the sealant during solder reflow. Such stresses are problematic because separation occurs at the interface between the sealant and the low-dielectric-constant interlayer dielectric or substrate, and the low-dielectric-constant interlayer dielectric cracks.

From the expectation that the use of leaded solders will be banned in the near future, a number of lead-substitute solders have been developed. Since most substitute solders have a higher melting temperature than the leaded solders, it has been considered to carry out reflow at temperatures of 250 to 270° C. At higher reflow temperatures, more failures are expected with encapsulants of prior art liquid epoxy resin compositions. Even with those packages which have raised no substantial problems in the prior art, the reflow at such high temperatures brings about serious problems that cracks can occur during the reflow and the encapsulant can peel at interfaces with chips or substrates. Also undesirably, cracks can occur in the resin, low-dielectric-constant interlayer dielectric, substrate, chip and bumps after several hundreds of thermal cycles.

The references pertinent to the present invention include Japanese Patent Nos. 3,238,340 and 3,351,974.

### SUMMARY OF THE INVENTION

An object of the invention is to provide a liquid epoxy resin composition for semiconductor encapsulation which cures into a cured product that has improved humidity resistant reliability and toughness, does not suffer a failure even when the temperature of reflow elevates from the conventional temperature of nearly 240° C. to 260-270° C., does not deteriorate under hot humid conditions as encountered in PCT (121° C./2.1 atm), and does not peel or crack over several hundred cycles of thermal cycling between −65° C. and 150° C. Another object of the invention is to provide a semiconductor device which is encapsulated with a cured product of the liquid epoxy resin composition.

The present invention generally pertains to a liquid epoxy resin composition comprising (A) a liquid epoxy resin, (B) an aromatic amine curing agent, and (C) an inorganic filler.

It has been found that better results are obtained when the aromatic amine curing agent (B) contains at least 5% by weight of an aromatic amine compound having the general formula (1), shown below, and the inorganic filler (C) has an average particle size in excess of 5 μm and is compounded in an amount of 300 to 1,000 parts by weight per 100 parts by weight of components (A) and (B) combined. The resulting liquid epoxy resin composition has a low viscosity and ease of working, is effectively adherent to the surface of silicon chips and inter alia, photosensitive polyimide resins and nitride films, especially nitride films, does not deteriorate under hot humid conditions as encountered in the PCT test (121° C./2.1 atm), and is fully resistant to thermal shocks. The composition is thus suited as an encapsulant for large die size semiconductor devices.

It has also been found that when the inorganic filler (C) is compounded in an amount of from more than 500 parts by weight of components (A) and (B) combined, and also when the composition exhibits a viscosity of up to 1,000 Pa.s at 25° C. and has in the cured state a coefficient of linear expansion α₁ of 7 to 10 ppm in a temperature range of 50 to 80° C. and α₂ of 20 to 50 ppm in a temperature range of 200 to 230° C., the resulting liquid epoxy resin composition cures into a cured product that has a very low coefficient of linear expansion, toughness, high modulus, and improved humidity resistance. The cured product is fully resistant to thermal shocks at a reflow temperature of at least 250° C., especially at least 260° C., and does not deteriorate under hot humid conditions as encountered in the PCT test (121° C./2.1 atm). Neither separation in the resin, substrate, and low-dielectric-constant interlayer dielectric (low-k layer) nor cracking in the encapsulant and low-dielectric-constant interlayer dielectric occurs over several hundred cycles of thermal cycling between −65° C. and 150° C. The composition is thus suited as a potting material for semiconductor devices, especially having low-dielectric-constant interlayer dielectrics.

It has also been found that when the inorganic filler (C) has a maximum particle size at most two-thirds as large as the size of a pitch between leads of a semiconductor device, the composition can be effectively cast and cured, without voids, in applications to cavity-down and chip-on-board (COB) semiconductor devices having a narrow lead pitch in addition that the composition is effective as an encapsulant for semiconductor devices having low-dielectric-constant interlayer dielectrics. The composition is improved in workability and suited as an encapsulant for large die size semiconductor devices.

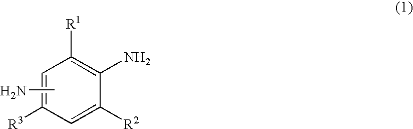

Herein, R¹ to R³ are each independently selected from among monovalent hydrocarbon groups of 1 to 6 carbon atoms, CH₃S— and C₂H₅S—.

As compared with conventional aromatic amine curing agents, the aromatic amine curing agent of the formula (1) imparts a prolonged pot-life to the epoxy resin composition despite relatively fast heat-curing performance, due to the inclusion of specific substituent groups, and provides a cured product having improved mechanical, electrical, heat resistant and chemical resistant properties. The use of the aromatic amine curing agent of the formula (1) ensures that the liquid epoxy resin composition becomes effectively adherent to the surface of silicon chips and especially photosensitive polyimide resins and nitride films, and significantly resistant to thermal shocks, and maintains satisfactory properties under hot humid conditions. As compared with conventional aromatic amine curing agents, the aromatic amine curing agent according to the invention has a low viscosity, leading to an epoxy resin composition having so low a viscosity that it may be worked and molded more easily.

Accordingly, a first embodiment of the present invention is a liquid epoxy resin composition comprising as essential components,
(A) a liquid epoxy resin,
(B) an aromatic amine curing agent containing at least 5% by weight of an aromatic amine compound having the general formula (1): 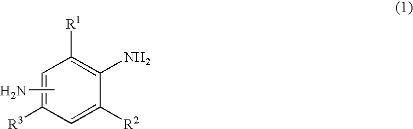
   wherein R¹ to R³ are each independently selected from among monovalent hydrocarbon groups of 1 to 6 carbon atoms, CH₃S— and C₂H₅S—, and
(C) an inorganic filler having an average particle size of more than 5 μm in an amount of from 300 parts by weight to 1,000 parts by weight per 100 parts by weight of components (A) and (B) combined.

A second embodiment of the present invention is a liquid epoxy resin composition comprising as essential components,
(A) a liquid epoxy resin,
(B) an aromatic amine curing agent containing at least 5% by weight of an aromatic amine compound having the general formula (1) defined above, and
(C) an inorganic filler having an average particle size of more than 5 μm in an amount of from more than 500 parts by weight to 1,000 parts by weight per 100 parts by weight of components (A) and (B) combined,
said composition exhibiting a viscosity of up to 1,000 Pa.s at 25° C. and having in the cured state a coefficient of linear expansion α₁ of 7 to 10 ppm in a temperature range of 50 to 80° C. and α₂ of 20 to 50 ppm in a temperature range of 200 to 230° C.

Preferably, the compositions further comprise an organic solvent having a boiling point of 130° C. to 250° C. in an amount of up to 50 parts by weight per 100 parts by weight of components (A) and (B) combined. The organic solvent preferably comprises an ester organic solvent desirably having the general formula (2):
R⁴COO—[R⁵—O]ₙ—R⁶ (2)
wherein R⁴ and R⁶ are monovalent hydrocarbon groups of 1 to 6 carbon atoms, R⁵ is an alkylene group of 1 to 6 carbon atoms, and n is an integer of 0 to 3.

The liquid epoxy resin (A) and the aromatic amine curing agent (B) are preferably compounded in such amounts that their equivalent ratio, expressed by the epoxy equivalent of the liquid epoxy resin (A) divided by the amine equivalent of the aromatic amine curing agent (B), is from 0.7 to 1.2.

In this case, the composition is preferably used with a semiconductor device having leads, wherein the inorganic filler (C) preferably comprises spherical fused silica having a maximum particle size at most two-thirds as large as the size of a pitch between the leads. The inorganic filler (C) also preferably has an average particle size at most one-half as large and a maximum particle size at most two-thirds as large as the size of a pitch between the leads.

The composition preferably comprises a silicone-modified resin in the form of a copolymer of an alkenyl-containing epoxy resin or alkenyl-containing phenolic resin with an organopolysiloxane of the following average compositional formula (3):
HₐR⁷_{b}SiO_{(4-a-b)/2} (3)
wherein R⁷ is a substituted or unsubstituted monovalent hydrocarbon group free of aliphatic unsaturation, “a” is a number of 0.01 to 0.1, “b” is a number of 1.8 to 2.2, and a+b is from 1.81 to 2.3, having 20 to 400 silicon atoms per molecule, the number of hydrogen atoms directly bonded to silicon atoms (SiH groups) being 1 to 5, the copolymer resulting from addition reaction of alkenyl groups on the epoxy or phenolic resin with SiH groups on the organopolysiloxane.

The present invention also provides a semiconductor device which is sealed with the liquid epoxy resin composition in the cured state, especially a semiconductor device having low-dielectric-constant interlayer dielectric or a cavity-down or chip-on-board semiconductor device which is sealed with the liquid epoxy resin composition in the cured state.

The liquid epoxy resin compositions of the invention have a very low coefficient of linear expansion, can be efficiently worked or processed, and ensure the fabrication of semiconductor devices which do not suffer a failure even when the temperature of reflow following moisture absorption elevates from the conventional temperature of nearly 240° C. to 250-270° C., do not deteriorate under hot humid conditions as encountered in the PCT test (121° C./2.1 atm), and do not peel or crack over several hundred cycles of thermal cycling between −65° C. and 150° C. In particular, the composition is useful as a potting material for semiconductor devices, especially having low-dielectric-constant interlayer dielectrics (low k layers). Moreover, the composition has a low viscosity and ease of working or processing, and cures into a product which is effectively adherent to the surface of silicon chips and especially photosensitive polyimide resins and nitride films.

### DESCRIPTION OF THE PREFERRED EMBODIMENTS

In the liquid epoxy resin composition of the invention, any epoxy resin may be used as the liquid epoxy resin (A) as long as it contains three or less epoxy functional groups in a molecule and is liquid at normal temperature. Useful liquid epoxy resins include bisphenol type epoxy resins such as bisphenol A epoxy resins and bisphenol F epoxy resins, naphthalene type epoxy resins and phenyl glycidyl ethers. Of these, epoxy resins which are liquid at room temperature are desirable. With respect to the viscosity of the liquid epoxy resin, the resin should preferably have a viscosity of up to 1,000 Pa.s, preferably up to 500 Pa.s, more preferably up to 200 Pa.s, and especially up to 100 Pa.s. The lower limit of viscosity is not critical in either embodiment and is typically at least 0.001 Pa.s, and especially at least 0.01 Pa.s. As used herein, the “viscosity” is a measurement at 25° C. by a Brookfield rotational viscometer.

The epoxy resin may comprise one or both of epoxy resins of the structural formulae (4) and (5) shown below insofar as infiltration ability is not compromised. 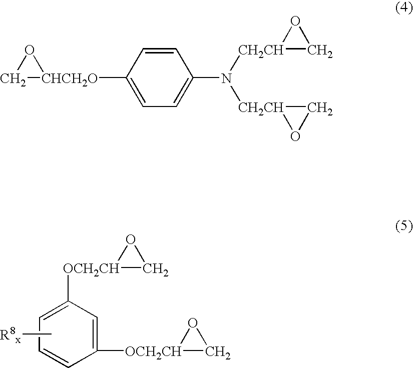
Herein, R⁸ is hydrogen or a monovalent hydrocarbon group having 1 to 20 carbon atoms, preferably 1 to 10 carbon atoms, more preferably 1 to 3 carbon atoms. Exemplary of the monovalent hydrocarbon group are alkyl groups such as methyl, ethyl and propyl, and alkenyl groups such as vinyl and allyl. The subscript x is an integer of 1 to 4, especially 1 or 2.

It is recommended that the epoxy resin of formula (5), if compounded, be used in an amount of at least 25% by weight, preferably at least 50% by weight, more preferably at least 75% by weight based on the entire epoxy resins. If the content of the epoxy resin of formula (5) is less than 25wt %, the composition may have an increased viscosity or the heat resistance of cured products may lower. The upper limit may be even 100% by weight. The epoxy resin of formula (5) is commercially available, for example, under the trade name of RE600NM from Nippon Kayaku Co., Ltd.

The liquid epoxy resin preferably has a total chlorine content of not more than 1,500 ppm, and especially not more than 1,000 ppm. When chlorine is extracted from the epoxy resin with water at an epoxy resin concentration of 50% and a temperature of 100° C. over a period of 20 hours, the water-extracted chlorine content is preferably not more than 10 ppm. A total chlorine content of more than 1,500 ppm or a water-extracted chlorine level of more than 10 ppm may exacerbate the reliability of the encapsulated semiconductor device, particularly in the presence of moisture.

The aromatic amine curing agent (B) used herein should contain at least 5% by weight, based on the entire aromatic amine curing agent, of an aromatic amine compound having the general formula (1). 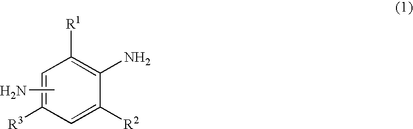
Herein R¹ to R³ are each independently selected from among monovalent hydrocarbon groups of 1 to 6 carbon atoms, CH₃S— and C₂H₅S—.

The monovalent hydrocarbon groups represented by R¹ to R³ have 1 to 6 carbon atoms, preferably 1 to 3 carbon atoms, including alkyl groups such as methyl, ethyl, propyl, isopropyl, butyl, isobutyl, tert-butyl and hexyl, alkenyl groups such as vinyl, allyl, propenyl, butenyl and hexenyl, phenyl groups, and halo-substituted monovalent hydrocarbon groups in which halogen atoms (e.g., chloro, fluoro, bromo) substitute for some or all of the hydrogen atoms on the foregoing groups, such as fluoromethyl, bromoethyl and trifluoropropyl.

Specific examples of the aromatic amine compound having the formula (1) include diethyltoluenediamine, dimethylthiotoluenediamine, and dimethyltoluenediamine.

The content of the aromatic amine compound having the formula (1) is at least 5% by weight, preferably 10 to 100% by weight, and more preferably 20 to 100% by weight, based on the entire aromatic amine curing agent. If the content of the aromatic amine compound having the formula (1) is less than 5% by weight based on the entire curing agent, there can arise an increased viscosity, a low bond strength or cracking.

The curing agents other than the above-mentioned aromatic amine compounds are preferably aromatic amines, and specifically aromatic diaminodiphenylmethane compounds such as 3,3′-diethyl-4,4′-diaminophenylmethane, 3,3′,5,5′-tetramethyl-4,4′-diaminophenylmethane, 3,3′,5,5′-tetraethyl-4,4′-diaminophenylmethane, 2,4-diaminotoluene, 1,4-diaminobenzene and 1,3-diaminobenzene.

Among the aromatic amine curing agents mentioned above, those agents which are liquid at normal temperature may be conveniently compounded as such. If the aromatic amine curing agent is solid at normal temperature, however, direct compounding of the aromatic amine curing agent with the epoxy resin results in a resin compound which has an increased viscosity and is awkward to work. It is then preferred to previously melt and mix the aromatic amine curing agent with the epoxy resin, more preferably in a predetermined proportion at a temperature in the range of 70 to 150° C. for 1 to 2 hours. At a mixing temperature below 70° C., the aromatic amine curing agent may be less miscible with the epoxy resin. A temperature above 150° C. can cause the aromatic amine curing agent to react with the epoxy resin to increase its viscosity. A mixing time of less than 1 hour is insufficient to achieve intimate mixing of the aromatic amine curing agent with the resin, inviting a viscosity increase. A time of more than 2 hours may allow the aromatic amine curing agent to react with the epoxy resin to increase its viscosity.

The total amount of the aromatic amine curing agent used herein should preferably be such that the equivalent ratio of the liquid epoxy resin to the aromatic amine curing agent, expressed by the epoxy equivalent of the liquid epoxy resin (A) divided by the amine equivalent of the aromatic amine curing agent (B), is in the range from 0.7/1 to 1.2/1, more preferably from 0.7/1 to 1.1/1, even more preferably from 0.85/1 to 1.05/1. If the compounding equivalent ratio is less than 0.7, unreacted amine groups are left, probably resulting in a lower glass transition temperature and poor adhesion. With an equivalent ratio in excess of 1.2, there is a possibility that the cured product becomes hard and brittle enough for cracks to form during the reflow operation or thermal cycling.

As the inorganic filler (C) in the inventive composition, any inorganic filler known to be useful for lowering the expansion coefficient may be added. Specific examples include fused silica, crystalline silica, aluminum, alumina, aluminum nitride, boron nitride, silicon nitride, magnesia and magnesium silicate. Of these, spherical fused silica is desirable for achieving low viscosity. The inorganic filler may have been surface treated with a silane coupling agent or the like although the inorganic filler can be used without surface treatment.

The inorganic filler (C) should have an average particle size of more than 5 μm, preferably from more than 5 μm to 20 μm, more preferably 7 to 15 μm, for providing a lower coefficient of expansion for reduced stresses. A filler with an average particle size of equal to or less than 5 μm provides an increased viscosity, substantially compromising working efficiency. A filler with too large an average particle size may settle down or cause the resin to crack.

The semiconductor devices to which the invention pertains are typically cavity-down and chip-on-board (COB) semiconductor devices having leads arranged at a pitch of about 30 to 120 μm. To attain both the purposes of improving the casting operation and entry into gaps between leads and of suppressing linear expansion, the inorganic filler (C) should preferably have a maximum particle size at most ⅔ as large as the pitch between leads. More desirably, the inorganic filler has a maximum particle size of 20 to 80 μm when the range of the pitch between leads in the semiconductor devices to which the invention pertains is taken into account. Too small a maximum particle size may lead to an increased viscosity whereas too large a maximum particle size indicates that particles will catch on lead wires, leaving unfilled areas or voids.

In this case, the inorganic filler should preferably have an average particle size at most ½, more preferably 1/100 to 3/7, most preferably 1/100 to ⅜ as large as the pitch between leads and a maximum particle size at most ⅔ as large as the pitch between leads.

In the invention, an inorganic filler having an average particle size of equal to or less than 5 μm may be used in combination with the inorganic filler having an average particle size of more than 5 μm. In this case, the amount of inorganic filler having an average particle size of equal to or less than 5 μshould preferably be 0.1 to 5% by weight, more preferably 0.5 to 4% by weight of the entire inorganic filler.

It is noted that the average particle size is determined as a weight average particle size (or median diameter), for example, by laser light diffraction analysis or the like. The maximum particle size is similarly determined by laser light diffraction analysis or the like. The absence of those particles having a size larger than ⅔ of the lead-to-lead pitch can be confirmed, for example, by mixing an inorganic filler with pure water in a weight ratio 1:9, treating the mixture with ultrasonic waves for thoroughly disintegrating agglomerates, sieving the mixture through a filter having an opening equal to ⅔ of the lead pitch, and examining if no inorganic filler is left on the filter.

The amount of the inorganic filler included in the composition is in a range of 300 parts to 1,000 parts by weight per 100 parts by weight of the liquid epoxy resin (A) and the curing agent (B) combined. Less than 300 pbw of the inorganic filler leads to a higher coefficient of linear expansion, which causes cracks in a thermal cycling test. More than 1,000 pbw of the inorganic filler leads to a higher viscosity to interfere with thin-film infiltration. The upper limit of the amount is preferably up to 950 parts by weight.

If the amount of the inorganic filler is more than 500 parts by weight per 100 parts by weight of components (A) and (B), the resulting composition is effective as an encapsulator for semiconductor devices having low-dielectric-constant interlayer dielectrics.

In the liquid epoxy resin composition of the invention, an organic solvent having a boiling point of 130 to 250° C. is preferably used for the purposes of improving operation efficiency and lowering viscosity. The boiling point of the organic solvent is preferably in the range of 140 to 230° C., more preferably 150 to 230° C. An organic solvent having a boiling point of lower than 130° C. will volatilize off during dispensing or cure, causing formation of voids. An organic solvent having a boiling point of higher than 250° C. will not volatilize off to the last during cure, which can cause a lowering of strength or adhesion.

Examples of suitable organic solvents include 2-ethoxyethanol, 1,2-propanediol, 1,2-ethanediol, diethylene glycol, xylene, cyclohexanone, cyclohexanol, formamide, acetamide, and diethylene glycol monoethyl ether acetate.

The preferred organic solvents are ester organic solvents. Solvents other than the ester organic solvents are less desirable. For example, alcoholic solvents or hydroxyl-bearing organic solvents can exacerbate the storage stability of the composition because hydroxyl groups readily react with amines. For this reason and for safety, ester organic solvents having the general formula (2) are preferred.
R⁴COO—[R⁵—O]ₙ—R⁶ (2)
Herein R⁴ and R⁶ each are a monovalent hydrocarbon group having 1 to 6 carbon atoms, R⁵ is an alkylene group having 1 to 6 carbon atoms, and n is an integer of 0 to 3.

Examples of the monovalent C₁-C₆ hydrocarbon groups represented by R⁴ and R⁶ are as exemplified above for R¹ to R³. Examples of the C₁-C₆ alkylene group represented by R⁵ include ethylene, propylene, methylethylene, butylene, pentene and hexene.

Examples of the ester organic solvents having formula (2) include 2-ethoxyethyl acetate, 2-butoxyethyl acetate, diethylene glycol monoethyl ether acetate, diethylene glycol monobutyl ether acetate, diethylene glycol ethyl ether acetate, and diethylene glycol butyl ether acetate.

The organic solvent is used in an amount of preferably 0 to 50 parts by weight, more preferably 0.5 to 50 parts by weight, most preferably 1 to 20 parts by weight per 100 parts by weight of the liquid epoxy resin (A) and the curing agent (B) combined. More than 50 pbw of the solvent results in a reduced crosslinking density, failing to provide a sufficient strength.

In the liquid epoxy resin composition of the invention, silicone rubbers, silicone oils, liquid polybutadiene rubbers, and thermoplastic resins such as methyl methacrylate-butadiene-styrene copolymers may be included for the stress reduction purpose. The preferred stress reducing agent is a silicone-modified resin in the form of a copolymer which is obtained from an alkenyl group-containing epoxy resin or alkenyl group-containing phenolic resin and an organopolysiloxane of the average compositional formula (3) containing per molecule 20 to 400 silicon atoms and 1 to 5 hydrogen atoms each directly attached to a silicon atom (i.e., SiH groups), by effecting addition of SiH groups to alkenyl groups.
HₐR⁷_{b}SiO_{(4-a-b)/2} (3)
Herein R⁷ is a substituted or unsubstituted monovalent hydrocarbon group free of aliphatic unsaturation, “a” is a number of 0.01 to 0.1, “b” is a number of 1.8 to 2.2, and the sum of a+b is from 1.81 to 2.3.

The aliphatic unsaturation-free monovalent hydrocarbon group represented by R⁷ preferably has 1 to 10 carbons, and especially 1 to 8 carbons. Illustrative examples include alkyl groups such as methyl, ethyl, propyl, isopropyl, butyl, isobutyl, tert-butyl, hexyl, octyl and decyl; aryl groups such as phenyl, xylyl and tolyl; aralkyl groups such as benzyl, phenylethyl and phenylpropyl; and halo-substituted monovalent hydrocarbon groups in which halogen atoms (e.g., chloro, fluoro, bromo) substitute for some or all of the hydrogen atoms on the foregoing hydrocarbon groups, such as fluoromethyl, bromoethyl and trifluoropropyl.

Copolymers having the following structure are preferred. 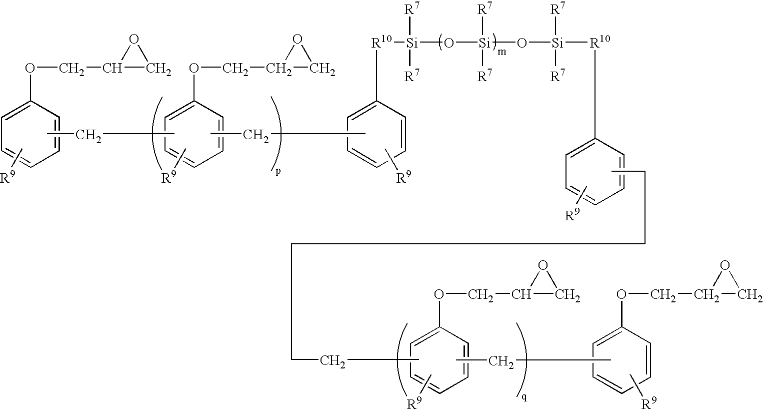
In the above formula, R⁷ is as defined above, R⁹ is a hydrogen atom or an alkyl of 1 to 4 carbons, such as methyl, ethyl, propyl, isopropyl, butyl, isobutyl and tert-butyl, and R¹⁰ is —CH₂CH₂CH₂—, —OCH₂—CH(OH)—CH₂—O—CH₂CH₂CH₂— or —O—CH₂CH₂CH₂—. The letter m is an integer from 4 to 199, and preferably from 19 to 99, p is an integer from 1 to 10, and q is an integer from 1 to 10.

The copolymer is included in the inventive composition such that the amount of diorganopolysiloxane units is 0 to 20 parts by weight, and preferably 2 to 15 parts by weight, per 100 parts by weight of the epoxy resin, whereby stress can be further reduced.

If necessary, the liquid epoxy resin composition may further contain additives as long as they do not compromise the objects of the invention. Suitable additives include carbon-functional silanes for improving adhesion, pigments (e.g., carbon black), dyes, and antioxidants. It is recommended that the addition of an alkoxy-bearing silane coupling agent as the carbon functional silane adhesion improver is excluded from the present invention although such a coupling agent can be used as the surface treating agent for the filler.

The liquid epoxy resin composition of the invention may be prepared by the simultaneous or discrete agitation, dissolution, mixing and dispersion of a liquid epoxy resin, an aromatic amine curing agent or a melt mixed masterbatch of liquid epoxy resin and aromatic amine curing agent, an inorganic filler, and optionally, an organic solvent and additives, while carrying out heat treatment if necessary. No particular limitation is imposed on the apparatus used for mixing, agitating, dispersing and otherwise processing the mixture of components. Exemplary apparatus suitable for this purpose include an automated mortar, three-roll mill, ball mill, planetary mixer and bead mill, coupled to agitator and heater units. Use can also be made of suitable combinations of these apparatuses.

The liquid epoxy resin composition should have a viscosity at 25° C. of up to 1,000 Pa.s, desirably up to 700 Pa.s, more desirably up to 600 Pa.s. A composition with a viscosity at 25° C. of more than 1,000 Pa.s is awkward to work. The lower limit of the viscosity is not limited although the viscosity at 25° C. is desirably at least 1 Pa.s.

An ordinary molding method and ordinary molding conditions may be employed in shaping the inventive composition. It is preferable to carry out an initial hot oven cure at 100 to 120° C. for at least 0.5 hour, especially 0.5 to 1 hour, followed by a subsequent hot oven cure at 165° C. for at least 1 hour, especially 1 to 4 hours. A cure time of less than 0.5 hour during 100 to 120° C. heating may result in void formation after curing. A post-cure time of less than 1 hour during 165° C. heating may yield a cured product having less than sufficient properties.

The cured composition should have a coefficient of linear expansion αₐ of 7 to 10 ppm, preferably 7 to 9 ppm, in a temperature range of 50 to 80° C. and α₂ of 20 to 50 ppm, preferably 20 to 45 ppm, in a temperature range of 200 to 230° C., as measured by a thermomechanical analyzer (TMA). Too low a coefficient of linear expansion α₁ leads to a higher resin viscosity whereas too high a coefficient of linear expansion α₁ leads to a higher stress, causing cracks. Too low a coefficient of linear expansion α₂ leads to a higher resin viscosity whereas too high a coefficient of linear expansion α₂ leads to a higher stress, causing cracks.

The epoxy resin composition is suited for use as a sealant or encapsulant in semiconductor devices, especially having low-dielectric-constant interlayer dielectrics. Such semiconductor devices include ultra-large scale integrated circuits (ULSI) for which an ultra-high degree of integration and an ultra-high speed of operation are required, such as CPU, DRAM and ASIC. Suitable low-dielectric-constant interlayer dielectrics include doped silicon oxide coatings such as SiOF and SiOC, organic polymer coatings, porous silica, and borazine-silicon polymers and have a relative dielectric constant of preferably 1.1 to 3.8, more preferably 1.1 to 2.5.

The epoxy resin composition is also suited for use as a sealant or encapsulant in cavity-down and chip-on-board (COB) semiconductor devices. Suitable cavity-down semiconductor devices include CPU and ASIC devices having a PGA or BGA structure. Suitable COB semiconductor devices include memory and logic LSI devices. The semiconductor device to which the invention is applicable is not limited to these.

When semiconductor devices are sealed or encapsulated with the epoxy resin composition, any sealing technique such as dispensing, stencil and printing techniques may be used.

### EXAMPLE

Examples of the invention and comparative examples are given below by way of illustration, and are not intended to limit the invention.

The resin compositions of Examples were examined by the following tests.

[Viscosity]

The viscosity at 25° C. was measured using a BH-type rotational viscometer at a rotational speed of 4 rpm. The viscosity at 25° C. was measured again after holding the composition at 40° C. for 24 hours.

[Void Test]

A polyimide-coated silicon chip of 5×5 mm having lead wires attached at a pitch of 50 μm was placed on a BT substrate of 30×30×2 mm to form a COB package. The resin composition was potted and cured to the package. Using a scanning acoustic microscope C-SAM (Hitachi Construction Machinery Co., Ltd.) and SEM, the sample was inspected for voids.

[Glass Transition Temperature (Tg)]

Using a sample of the cured composition measuring 5×5×15 mm, the glass transition temperature was measured with a thermomechanical analyzer at a heating rate of 5° C./min.

[Coefficients of Thermal Expansion (CTE)]

Based on the Tg measurement described above, a coefficient of thermal expansion below Tg (α₁) was determined for a temperature range of 50 to 80° C., and a coefficient of thermal expansion above Tg (α₂) was determined for a temperature range of 200 to 230° C.

[Bond Strength Test]

On a polyimide-coated silicon chip was rested a frustoconical sample having a top diameter of 2 mm, a bottom diameter of 5 mm and a height of 3 mm. It was cured at 165° C. for 3 hours. At the end of curing, the sample was measured for (initial) shear bond strength. The cured sample was then placed in a pressure cooker test (PCT) environment of 121° C. and 2.1 atm for 336 hours for moisture absorption. At the end of PCT test, shear bond strength was measured again. In each Example, five samples were used, from which an average bond strength value was calculated.

[PCT Peel Test]

A polyimide-coated 15×15 mm silicon chip was placed on a 30×30×2 mm BT substrate to form a COB package having a gap of 120 μm. The epoxy resin composition was potted and cured to the package. The assembly was held at 30° C. and RH 65% for 192 hours and then processed 5 times by IR reflow set at a maximum temperature of 265° C., before the assembly was checked for peeling. The assembly was then placed in a PCT environment of 121° C. and 2.1 atm for 336 hours, before the assembly was checked for peeling. Peeling was inspected by C-SAM (Hitachi Construction Machinery Co., Ltd.).

[Thermal Shock Test]

A polyimide-coated 15×15 mm silicon chip was placed on a 30×30×2 mm BT substrate to form a COB package having a gap of 120 μm. The epoxy resin composition was potted and cured to the package. The assembly was held at 30° C. and RH 65% for 192 hours and then processed 5 times by IR reflow set at a maximum temperature of 265° C. The assembly was then tested by thermal cycling between −65° C./30 minutes and 150° C./30 minutes. After 250, 500, 750 and 1000 cycles, the assembly was examined for peeling (or delamination) and cracks.

### Examples and Comparative Examples

The components shown in Tables 1 to 3 were intimately mixed on a three-roll mill to give nine resin compositions. These resin compositions were examined by the above tests. The results are shown in Tables 1 to 3.

TABLE 1

| Composition | | Example | | | | | |
|---|---|---|---|---|---|---|---|
| (pbw) | | 1 | 2 | 3 | 4 | 5 | 6 |
| Curing | Curing agent A | 26.0 | | | 30.6 | 26.0 | 3.1 |
| agent | Curing agent B | | 29.8 | | | | |
| | Curing agent C | | | 22.8 | | | |
| | C-300S | | | | | | 36.1 |
| Resin | RE303S-L | 37.0 | 35.1 | 38.6 | 34.7 | 37.0 | 30.4 |
| | Epikote 630H | 37.0 | 35.1 | 38.6 | 34.7 | 37.0 | 30.4 |
| Equivalent ratio of | | 1.0 | 1.0 | 1.0 | 0.8 | 1.0 | 1.0 |
| epoxy resin/curing agent | | | | | | | |
| Filler | Spherical silica A | 380 | 380 | 380 | 380 | 500 | 380 |
| | Spherical silica B | | | | | | |
| | Fumed silica | 3.0 | 3.0 | 3.0 | 3.0 | 3.0 | 3.0 |
| | Carbon black | | | | | | |
| Additive | KBM403 | 1 | 1 | 1 | 1 | 1 | 1 |
| | Copolymer | 4 | 4 | 4 | 4 | 4 | 4 |
| | Solvent A | | | | | | |
| | Solvent B | | | | | | |

Test results

| Viscosity @25° C. (Pa · s) | | 78.8 | 76.5 | 89.8 | 75.8 | 209.2 | 82.2 |
|---|---|---|---|---|---|---|---|
| Viscosity @25° C. (Pa · s) | | 146.9 | 151.8 | 169.5 | 153.7 | 514.7 | 193.0 |
| after 40° C./24 hr | | | | | | | |
| Void test | | nil | nil | nil | nil | nil | nil |
| Tg (° C.) | | 140 | 136 | 140 | 138 | 139 | 128 |
| α₁ (ppm/° C.) | | 17 | 17 | 18 | 18 | 12 | 17 |
| α₂ (ppm/° C.) | | 62 | 65 | 58 | 60 | 61 | 60 |
| Peel test | After 5 times | no | no | no | no | no | no |
| | of IR reflow | peeling | peeling | peeling | peeling | peeling | peeling |
| | at 265° C. | | | | | | |
| | After | no | no | no | no | no | no |
| | PCT 336 hr | peeling | peeling | peeling | peeling | peeling | peeling |
| Bond | Initial | 211 | 198 | 205 | 184 | 194 | 215 |
| strength | After PCT 336 hr | 116 | 131 | 163 | 147 | 155 | 163 |
| (kgf/cm²) | | | | | | | |
| Failure | 250 cycles | 0 | 0 | 0 | 0 | 0 | 0 |
| (%) | 500 cycles | 0 | 0 | 0 | 0 | 0 | 0 |
| after | 750 cycles | 0 | 0 | 0 | 0 | 0 | 0 |
| thermal | 1000 cycles | 0 | 0 | 0 | 0 | 0 | 0 |
| shock test | | | | | | | |

TABLE 2

| | | | | | | Comparative | |
|---|---|---|---|---|---|---|---|
| Composition | | Example | | | | Example | |
| (pbw) | | 7 | 8 | 9 | 10 | 1 | 2 |
| Curing | Curing agent A | 26.0 | 26.0 | 26.0 | 26.0 | | 0.9 |
| agent | Curing agent B | | | | | | |
| | Curing agent C | | | | | | |
| | C-300S | | | | | 40.6 | 29.9 |
| Resin | RE303S-L | 37.0 | 37.0 | 37.0 | 37.0 | 29.7 | 69.2 |
| | Epikote 630H | 37.0 | 37.0 | 37.0 | 37.0 | 29.7 | |
| Equivalent ratio of | | 1.0 | 1.0 | 1.0 | 1.0 | 1.0 | 1.0 |
| epoxy resin/curing agent | | | | | | | |
| Filler | Spherical silica A | 380 | 380 | | 380 | 380 | 380 |
| | Spherical silica B | | | 380 | | | |
| | Fumed silica | 3.0 | 3.0 | 3.0 | 3.0 | 3.0 | 3.0 |
| | Carbon black | | | | | | |
| Additive | KBM403 | 1 | 1 | 1 | 1 | 1 | 1 |
| | Copolymer | 4 | 4 | 4 | 4 | 4 | 4 |
| | Solvent A | 2.5 | 5.0 | 2.5 | | | |
| | Solvent B | | | | 2.5 | | |

Test results

| Viscosity @25° C. (Pa · s) | | 55.6 | 31.0 | 51.4 | 63.9 | 118 | 105 |
|---|---|---|---|---|---|---|---|
| Viscosity @25° C. (Pa · s) | | 100.1 | 85.6 | 103.4 | 140.8 | 253 | 221 |
| after 40° C./24 hr | | | | | | | |
| Void test | | nil | nil | nil | nil | voids | voids |
| Tg (° C.) | | 124 | 90 | 123 | 105 | 100 | 101 |
| α₁ (ppm/° C.) | | 18 | 18 | 17 | 18 | 18 | 17 |
| α₂ (ppm/° C.) | | 67 | 65 | 66 | 65 | 66 | 65 |
| Peel test | After 5 times | no | no | no | no | no | no |
| | of IR reflow | peeling | peeling | peeling | peeling | peeling | peeling |
| | at 265° C. | | | | | | |
| | After | no | no | no | no | peeled | peeled |
| | PCT 336 hr | peeling | peeling | peeling | peeling | | |
| Bond | Initial | 195 | 194 | 191 | 161 | 166 | 151 |
| strength | After PCT 336 hr | 124 | 147 | 134 | 121 | 107 | 102 |
| (kgf/cm²) | | | | | | | |
| Failure | 250 cycles | 0 | 0 | 0 | 0 | 0 | 0 |
| (%) | 500 cycles | 0 | 0 | 0 | 0 | 30 | 10 |
| after | 750 cycles | 0 | 0 | 0 | 0 | 70 | 50 |
| thermal | 1000 cycles | 0 | 0 | 0 | 20 | 100 | 85 |
| shock test | | | | | | | |

TABLE 3

| | | | | | | | | Comparative | | |
|---|---|---|---|---|---|---|---|---|---|---|
| Composition | | Example | | | | | | Example | | |
| (pbw) | | 11 | 12 | 13 | 14 | 15 | 16 | 3 | 4 | 5 |
| Curing | Curing agent A | 16 | | | 16 | 16 | 16 | | 16 | 16 |
| agent | Curing agent B | | 17.5 | | | | | | | |
| | Curing agent C | | | 15 | | | | | | |
| | C-300S | 16 | 17.5 | 15 | 16 | 16 | 16 | 32 | 16 | 16 |
| Resin | RE303S-L | 34 | 32.5 | 35 | 34 | 34 | 34 | 34 | 34 | 34 |
| | Epikote 630H | 34 | 32.5 | 35 | 34 | 34 | 30 | 34 | 34 | 34 |
| Equivalent ratio of | | 1.0 | 1.0 | 1.0 | 1.0 | 1.0 | 1.0 | 1.0 | 1.0 | 1.0 |
| epoxy resin/curing agent | | | | | | | | | | |
| Filler | Spherical | 900 | 900 | 900 | 900 | 900 | 900 | 900 | 900 | 300 |
| | silica A | | | | | | | | | |
| | Spherical | | | | | | | | | |
| | silica B | | | | | | | | | |
| | Carbon black | 1.5 | 1.5 | 1.5 | 1.5 | 1.5 | 1.5 | 1.5 | 1.5 | 1.5 |
| Additive | KBM403 | 1.5 | 1.5 | 1.5 | 1.5 | 1.5 | 1.5 | 1.5 | 1.5 | 1.5 |
| | Copolymer | | | | | | 4 | | | |
| | Solvent A | | | | 20 | | | | 70 | |
| | Solvent B | | | | | 20 | | | | |

Test results

| Viscosity @25° C. (Pa · s) | | 800 | 770 | 840 | 210 | 220 | 800 | 1230 | 12 | 65 |
|---|---|---|---|---|---|---|---|---|---|---|
| Void test | | nil | nil | nil | nil | nil | nil | voids | voids | nil |
| Tg (° C.) | | 170 | 165 | 170 | 168 | 165 | 173 | 158 | 155 | 167 |
| α₁ (ppm/° C.) | | 7.6 | 8.2 | 8.3 | 8.2 | 8.1 | 9.5 | 8.5 | 10.2 | 13.2 |
| α₂ (ppm/° C.) | | 26.2 | 28.3 | 27.8 | 29.2 | 30.3 | 28.0 | 35.3 | 35.9 | 64.3 |
| Peel | After 5 times | no | no | no | no | no | no | no | peeled | no |
| test | of IR reflow | peeling | peeling | peeling | peeling | peeling | peeling | peeling | | peeling |
| | at 265° C. | | | | | | | | | |
| | After | no | no | no | no | no | no | no | no | no |
| | PCT 336 hr | peeling | peeling | peeling | peeling | peeling | peeling | peeling | peeling | peeling |
| Failure | 250 cycles | 0 | 0 | 0 | 0 | 0 | 0 | 0 | 0 | 0 |
| (%) | 500 cycles | 0 | 0 | 0 | 0 | 0 | 0 | 0 | 0 | 0 |
| after | 750 cycles | 0 | 0 | 0 | 0 | 0 | 0 | 0 | 0 | 20 |
| thermal | 1000 cycles | 0 | 0 | 0 | 0 | 0 | 0 | 0 | 20 | 60 |
| shock | | | | | | | | | | |
| test | | | | | | | | | | |

Curing agent A: diethyltoluenediamine (Mw=178)
Curing agent B: dimethylthiotoluenediamine (Mw=214.4)
Curing agent C: dimethyltoluenediamine (Mw=150)
C-300S: tetraethyldiaminophenylmethane, Nippon Kayaku Co., Ltd.
RE303S-L: bisphenol F epoxy resin, Nippon Kayaku Co., Ltd.
Epikote 630H: trifunctional epoxy resin, Japan Epoxy Resin Co., Ltd. 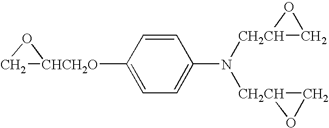
Silica A: spherical fused silica having an average particle size of 12.5 μm and a maximum particle size of 80 μm
Silica B: spherical silica having an average particle size of 12.8 μm and a maximum particle size of 80 μm, prepared by the sol-gel process
Fumed silica: surface treated inorganic filler, fumed silica surface treated with hexamethylsilazane SE31 (Shin-Etsu Chemical Co., Ltd.) having an average particle size of 0.15 μm, trade name Aerosil 130 by Nippon Aerosil Co., Ltd.
KBM403: silane coupling agent, γ-glycidoxypropyltrimethoxy-silane, Shin-Etsu Chemical Co., Ltd.
Carbon black: Denka Black, Denki Kagaku Kogyo K. K.
Solvent A: 2-butoxyethyl acetate, boiling point 192° C.
Solvent B: propylene glycol monomethyl ether acetate (PGMEA), boiling point 146° C.
   Copolymer: the addition reaction product of

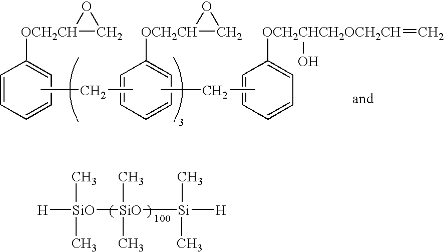

Japanese Patent Application Nos. 2003-415182 and 2003-415202 are incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A liquid epoxy resin composition comprising
(A) a liquid epoxy resin,
(B) an aromatic amine curing agent containing at least 5% by weight of an aromatic amine compound having the general formula (1): 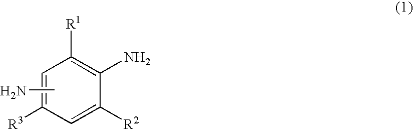
wherein R¹ to R³ are each independently selected from the group consisting of monovalent hydrocarbon groups of 1 to 6 carbon atoms, CH₃S— and C₂H₅S—, and
(C) an inorganic filler having an average particle size of more than 5 μm in an amount of from 300 parts by weight to 1,000 parts by weight per 100 parts by weight of components (A) and (B) combined.

2. A liquid epoxy resin composition comprising
(A) a liquid epoxy resin,
(B) an aromatic amine curing agent containing at least 5% by weight of an aromatic amine compound having the general formula (1): 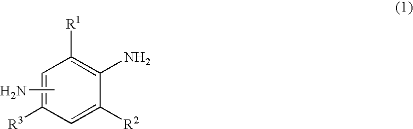
wherein R¹ to R³ are each independently selected from the group consisting of monovalent hydrocarbon groups of 1 to 6 carbon atoms, CH₃S— and C₂H₅S—, and
(C) an inorganic filler having an average particle size of more than 5 μm in an amount of from more than 500 parts by weight to 1,000 parts by weight per 100 parts by weight of components (A) and (B) combined,
said composition exhibiting a viscosity of up to 1,000 Pa.s at 25° C. and having in the cured state a coefficient of linear expansion α₁ of 7 to 10 ppm in a temperature range of 50 to 80° C. and α₂ of 20 to 50 ppm in a temperature range of 200 to 230° C.

3. The composition of claim 1, further comprising an organic solvent having a boiling point of 130° C. to 250° C. in an amount of up to 50 parts by weight per 100 parts by weight of components (A) and (B) combined.

4. The composition of claim 3, wherein said organic solvent comprises an ester organic solvent.

5. The composition of claim 4, wherein said ester organic solvent has the general formula (2):
R⁴COO—[R⁵—O]_{n—R}⁶
wherein R⁴ and R⁶ are monovalent hydrocarbon groups of 1 to 6 carbon atoms, R⁵ is an alkylene group of 1 to 6 carbon atoms, and n is an integer of 0 to 3.

6. The composition of claim 1, wherein the liquid epoxy resin (A) and the aromatic amine curing agent (B) are compounded in such amounts that their equivalent ratio, expressed by the epoxy equivalent of the liquid epoxy resin (A) divided by the amine equivalent of the aromatic amine curing agent (B), is from 0.7 to 1.2.

7. The composition of claim 1, which is used with a semiconductor device having leads, wherein the inorganic filler (C) comprises spherical fused silica having a maximum particle size at most two-thirds as large as the size of a pitch between the leads.

8. The composition of claim 1, which is used with a semiconductor device having leads, wherein the inorganic filler (C) has an average particle size at most one-half as large and a maximum particle size at most two-thirds as large as the size of a pitch between the leads.

9. The composition of claim 1, further comprising a silicone-modified resin in the form of a copolymer of an alkenyl-containing epoxy resin or alkenyl-containing phenolic resin with an organopolysiloxane of the following average compositional formula (3):
HₐR⁷_{b}SiO_{(4-a-b)/2} (3)
wherein R⁷ is a substituted or unsubstituted monovalent hydrocarbon group free of aliphatic unsaturation, “a” is a number of 0.01 to 0.1, “b” is a number of 1.8 to 2.2, and a+b is from 1.81 to 2.3, having 20 to 400 silicon atoms per molecule, the number of hydrogen atoms directly bonded to silicon atoms (SiH groups) being 1 to 5, the copolymer resulting from addition reaction of alkenyl groups on the epoxy or phenolic resin with SiH groups on the organopolysiloxane.

10. The composition of claim 2, further comprising an organic solvent having a boiling point of 130° C. to 250° C. in an amount of 0.5 to 10 parts by weight per 100 parts by weight of components (A) and (B) combined.

11. The composition of claim 10, wherein said organic solvent comprises an ester organic solvent.

12. The composition of claim 11, wherein said ester organic solvent has the general formula (2):
R⁴COO—[R⁵—O]_{n—R}⁶ (2)
wherein R⁴ and R⁶ are monovalent hydrocarbon groups of 1 to 6 carbon atoms, R⁵ is an alkylene group of 1 to 6 carbon atoms, and n is an integer of 0 to 3.

13. The composition of claim 2, wherein the liquid epoxy resin (A) and the aromatic amine curing agent (B) are compounded in such amounts that their equivalent ratio, expressed by the epoxy equivalent of the liquid epoxy resin (A) divided by the amine equivalent of the aromatic amine curing agent (B), is from 0.7 to 1.2.

14. The composition of claim 2, which is used with a semiconductor device having leads, wherein the inorganic filler (C) comprises spherical fused silica having a maximum particle size at most two-thirds as large as the size of a pitch between the leads.

15. The composition of claim 2, which is used with a semiconductor device having leads, wherein the inorganic filler (C) has an average particle size at most one-half as large and a maximum particle size at most two-thirds as large as the size of a pitch between the leads.

16. The composition of claim 2, further comprising a silicone-modified resin in the form of a copolymer of an alkenyl-containing epoxy resin or alkenyl-containing phenolic resin with an organopolysiloxane of the following average compositional formula (3):
HₐR⁷_{b}SiO_{(4-a-b)/2} (3)
wherein R⁷ is a substituted or unsubstituted monovalent hydrocarbon group free of aliphatic unsaturation, “a” is a number of 0.01 to 0.1, “b” is a number of 1.8 to 2.2, and a+b is from 1.81 to 2.3, having 20 to 400 silicon atoms per molecule, the number of hydrogen atoms directly bonded to silicon atoms (SiH groups) being 1 to 5, the copolymer resulting from addition reaction of alkenyl groups on the epoxy or phenolic resin with SiH groups on the organopolysiloxane.

17. A semiconductor device which is sealed with the liquid epoxy resin composition of claim 1 in the cured state.

18. A semiconductor device having low-dielectric-constant interlayer dielectric which is sealed with the liquid epoxy resin composition of claim 1 in the cured state.

19. A semiconductor device which is sealed with the liquid epoxy resin composition of claim 2 in the cured state.

20. The semiconductor device of claim 19, which is a cavity-down or chip-on-board semiconductor device.
